(19) United States
(12) Patent Application Publication
(10) Pub. No.: US 2015/0270071 A1
(43) Pub. Date: Sep. 24, 2015

(54) CARBON MATERIAL FOR ELECTRICAL STORAGE DEVICE, METHOD OF MANUFACTURING THE SAME, AND ELECTRICAL STORAGE DEVICE USING THE SAME

(71) Applicant: IBIDEN CO., LTD., Ogaki-shi (JP)

(72) Inventors: Takahiko Ido, Ibi-gun (JP); Takuya Takagi, Ibi-gun (JP)

(73) Assignee: IBIDEN CO., LTD., Ogaki-shi (JP)

(21) Appl. No.: 14/434,405

(22) PCT Filed: Oct. 7, 2013
(86) PCT No.: PCT/JP2013/077253

§ 371 Date: Apr. 9, 2015

(30) Foreign Application Priority Data
Oct. 9, 2012 (JP) 2012-224117

(51) Int. Cl. H01G 11/42; H01M 10/0525; H01M 4/587

(52) U.S. Cl. CPC H01G 11/42; H01M 4/587; H01M 10/0525

(57) ABSTRACT

Provided are: a carbon material for an electrical storage device which exhibits, even under low-temperature conditions, sufficiently excellent characteristics from the standpoint of resistivity; and a process for manufacturing the same. This carbon material for an electrical storage device is a carbon material made by pulverizing a graphite material and in which the 10% volume cumulative diameter, 50% volume cumulative diameter and 90% volume cumulative diameter are controlled to 0.45 to 1.7 μm, 0.8 to 4.0 μm and 1.55 to 8.9 μm respectively, and the volume average particle diameter distribution has at least a second peak with the highest frequency of appearance and a first peak located on the side of a particle diameter smaller than that of the second peak. The use of the carbon material in an electrical storage device makes it possible to lower the low-temperature charge transfer resistance of the device.

### TECHNICAL FIELD

The present invention relates to a carbon material for an electrical storage device, a method of manufacturing it, and an electrical storage device using it. More particularly, the present invention relates to a carbon material for a negative electrode of a lithium-ion secondary battery or a lithium-ion capacitor having excellent low-temperature characteristics, a method of manufacturing it, and an electrical storage device using it.

### BACKGROUND ART

As electrical storage devices for uses that require high-energy density and high-output characteristics, electrical storage devices on the combined electrical storage principles of lithium-ion secondary batteries and electric double layer capacitors have received attention in recent years. Such electrical storage devices are called hybrid capacitors. For hybrid capacitors, those intended to largely increase the energy density by causing a negative electrode to absorb and support lithium ions in advance by a chemical method or an electrochemical method to lower its negative electrode potential have been proposed. A negative electrode of such a capacitor is produced by a method of bringing a negative electrode capable of occluding and desorbing lithium ions into contact with a lithium metal for pretreatment.

A capacitor of the above-described type with a negative electrode doped with lithium ions, that is, a lithium-ion capacitor exhibits a phenomenon in which its characteristics are significantly degraded under a low temperature of about −20° C. to −10° C. When a lithium-ion capacitor is used as an electrical storage device for an automobile or the like, extreme importance is placed on its characteristics under the above-described low temperatures to withstand use in cold areas.

For the above problem, Patent Literature 1 reports that by setting the 50% volume cumulative diameter of polyacene-based negative-electrode active material particles to 0.1 to 2.0 μm in a lithium-ion capacitor, the low-temperature characteristics can be improved. That is, it is disclosed that the capacitance at −20° C. can be improved.

### CITATION LIST

### Patent Literature

Patent Literature 1: JP 2006-303330 A

### SUMMARY OF INVENTION

### Technical Problem

Carbon materials include kinds other than polyacene-based materials, such as coke, hard carbon, and graphite. These carbon materials have a hexagonal-crystal-system crystalline form. Since such a crystalline structure is bonded by Van der Waals forces in the c-axis direction, these carbon materials can be said to be materials with high cleavability. It is also known that as the crystallinity increases, the cleavability increases and they become softer, and pulverized particles have a scale-like shape. That is, the crystallinity of the carbon materials is considered to have large effect on their grindability and pulverized shapes.

The polyacene-based carbon material described in Patent Literature 1 is a material obtained by carbonizing a phenol resin or the like, and is evaluated as a material with relatively poor crystallinity compared with the other carbon materials.

On the other hand, graphite materials among the carbon materials include synthetic graphite made by graphitizing at a high temperature easily-graphitizable carbon such as cork and pitch as a row material, natural graphite produced as natural resources, and the like. Compared with polyacene-based materials, these graphite materials have high crystallinity and thus high cleavability, and their pulverization into fine particles can be said to be difficult. Further, since particles obtained by pulverizing the graphite materials have high aspect ratios, it is very difficult for them to provide performance equal to that of the polyacene-based materials by being pulverized into fine particles to reduce the charge-transfer resistance at low temperatures.

The present invention has been made in view of these problems of the conventional art. The object of the present invention is to provide a carbon material for an electrical storage device configured to be able to reduce charge-transfer resistance at low temperatures by pulverizing a carbon material with high crystallinity and cleavability into fine particles, a method of manufacturing it, and an electrical storage device using it.

### Solution to Problem

A carbon material for an electrical storage device according to a first aspect of the present invention is a carbon material for an electrical storage device made by pulverizing a graphite material, in which the 10% volume cumulative diameter is controlled to be 0.45 μm or more to 1.7 μm or less, the 50% volume cumulative diameter to be 0.8 μm or more to 4.0 μm or less, and the 90% volume cumulative diameter to be 1.55 μm or more to 8.9 μm or less, respectively. Further, it is characterized in that the volume average particle diameter distribution has at least a second peak with the highest frequency of appearance and a first peak located on the side of a particle diameter smaller than that of the second peak.

The carbon material for an electrical storage device according to a second aspect of the present invention is characterized in that the first peak is present in a first range of 0.01 μm or more to less than 1 μm in particle diameter, and the second peak is present in a second range of 1 μm or more to 10 μm or less in particle diameter.

The carbon material for an electrical storage device according to a third aspect of the present invention is characterized in that the abundance ratio (X) between a carbon material (a) included in the first range and a carbon material (b) included in the second range determined by the following Mathematical Formula 1 is in a range of 0.1 to 0.9:

$$\begin{matrix}[ Mathematical 1 ] & \\ X = \frac{A}{B} & ( Mathematical Formula 1 )\end{matrix}$$

(wherein, A represents the maximum frequency of appearance of the carbon material (a), and B represents the maximum frequency of appearance of the carbon material (b).)

The carbon material for an electrical storage device according to a fourth aspect of the present invention is characterized in that components constituting the second peak and components constituting the first peak are simultaneously obtained by pulverizing the graphite material by a fluidized-bed jet mill.

A carbon material negative electrode for an electrical storage device according to a fifth aspect of the present invention is characterized in that it includes the carbon material for an electrical storage device of the present invention.

An electrical storage device according to a sixth aspect of the present invention is characterized in that it includes the carbon material for an electrical storage device of the present invention or the negative electrode for an electrical storage device of the present invention.

The electrical storage device according to a seventh aspect of the present invention is characterized in that it constitutes a lithium-ion secondary battery or a lithium-ion capacitor.

A method of manufacturing the carbon material for an electrical storage device according to an eighth aspect of the present invention is a manufacturing method of manufacturing the carbon material for an electrical storage device of the present invention, and is characterized in that it includes the step of pulverizing the graphite material by a fluidized-bed jet mill.

The method of manufacturing the carbon material for an electrical storage device according to a ninth aspect of the present invention is characterized in that an isotropic graphite material containing amorphous cork as a raw material is used as the graphite material.

The disclosure of this application is related to the subject described in Patent Application No. 2012-224117, filed on Oct. 9, 2012 in Japan, the disclosed contents of which are cited herein by reference.

### Advantageous Effects of Invention

The carbon material for an electrical storage device of the present invention is bimodal in the particle diameter distribution of the graphite material having high cleavability, and thus can significantly reduce charge-transfer resistance under a low-temperature environment when the material is used for an electrical storage device. As a result, it can provide an electrical storage device that exhibits excellent output characteristics even under a low-temperature environment.

Further, according to the method of manufacturing the carbon material for an electrical storage device of the present invention, the graphite material having high cleavability is pulverized by the jet mill, so that a carbon material having a bimodal particle diameter distribution can be obtained. As a result, it is suitable for manufacturing a carbon material for an electrical storage device that can reduce charge-transfer resistance under a low-temperature environment when it is applied to an electrical storage device.

Furthermore, the electrical storage device of the present invention is reduced in charge-transfer resistance under a low-temperature environment since the carbon material for an electrical storage device of the present invention is applied thereto. As a result, it can exhibit excellent output characteristics even under a low-temperature environment.

### BRIEF DESCRIPTION OF DRAWINGS

FIG. 1(a) is a schematic diagram illustrating a manner in which current flows through a carbon material for an electrical storage device according to an embodiment of the present invention, the carbon material having a bimodal volume average particle diameter distribution.

FIG. 1(b) is a schematic diagram illustrating a manner in which current flows through a carbon material for an electrical storage device according to an embodiment of the present invention, the carbon material having a single-peak volume average particle diameter distribution.

FIG. 2 is an explanatory diagram for identifying peaks when the volume average particle diameter distribution of the carbon material for an electrical storage device according to the embodiment of the present invention does not exhibit a maximum.

FIG. 3 is a Cole-Cole plot in which the real part and the imaginary part of impedance obtained by alternating-current impedance measurement are plotted.

FIG. 4 is a particle diameter distribution when carbon materials according to examples and comparative examples are evaluated in volume-based frequency.

FIG. 5 is a graph of examples and a comparative example showing the relationships between abundance ratios and resistance values of two kinds of carbon material with different particle diameters.

### DESCRIPTION OF EMBODIMENT

Hereinafter, an embodiment of the present invention will be described in detail with reference to the drawings.

[Carbon Material for Electrical Storage Device]

A carbon material for an electrical storage device of the present invention is made by pulverizing a graphite material.

Graphite materials include synthetic graphite made by treating at a high temperature an easily-graphitizable material such as cork or pitch as a raw material, natural graphite produced as natural resources, and the like. These graphite materials are produced in large quantity in graphite-related industries for electrodes for making steel, isotropic graphite materials, and the like, and processed powder thereof or the like is easily available. Natural graphite is produced as natural resources, and does not particularly need heat treatment, and thus is easily available.

The carbon material for electrical battery devices of the present invention has the 10% volume cumulative diameter controlled to 0.45 μm or more to 1.7 μm or less, the 50% volume cumulative diameter to 0.8 μm or more to 4.0 μm or less, and the 90% volume cumulative diameter to 1.55 μm or more to 8.9 μm or less, respectively.

Here, the 10% volume cumulative diameter, the 50% volume cumulative diameter, and the 90% volume cumulative diameter can be measured by a typical laser diffraction method, for example. Specifically, the 10% volume cumulative diameter, the 50% volume cumulative diameter, and the 90% volume cumulative diameter are particle sizes (diameters) representing 10%, 50%, and 90%, respectively, of the volume particle diameter cumulative frequency distribution in the laser diffraction method.

In an electrical storage device using lithium ions for an electrolyte, the surface area of the carbon material is preferably large and the particle diameter thereof is preferably small for smooth transfer of the lithium ions at an interface between the carbon material and the electrolyte. In particular, a 50% volume cumulative diameter of 4.0 μm or less allows for smooth transfer of lithium ions at an interface between a negative electrode of the carbon material and the electrolyte, and allows for a reduction in resistance.

By thus controlling the 50% volume cumulative diameter measured to 4.0 μm or less, a sufficient specific surface area of the carbon material can be ensured. Therefore, by the application of such a carbon material to an electrical storage device, the charge-transfer resistance can be sufficiently reduced. When the 50% volume cumulative diameter exceeds 4.0 μm, the specific surface area is reduced, and the charge-transfer resistance tends to increase.

When the 10% volume cumulative diameter is less than 0.45 μm, there are too much fine particles, increasing the volume of the electrode. Thus it is estimated that the volume-based electrical storage capacity becomes small. When the 10% volume cumulative diameter exceeds 1.0 μm, it is estimated that two peaks overlap and it becomes difficult to form a bimodal particle diameter distribution. In terms of this, it is desirable to set the range of the 10% volume cumulative diameter to 0.45 or more to 1.0 μm or less.

When the 90% volume cumulative diameter is less than 1.55 μm, it is estimated that two peaks overlap and it becomes difficult to form a bimodal particle diameter distribution. When it exceeds 8.9 μm, it is estimated that a sufficient specific surface area cannot be provided and the charge-transfer resistance becomes large. In terms of this, it is desirable to set the range of the 90% volume cumulative diameter to 1.8 μm or more to 6.0 μm or less.

On the other hand, it is known that in an electrical storage device using lithium ions as an electrolyte, a solid electrolyte interface (SEI) is formed on the surfaces of carbon material particles constituting a negative electrode. An SEI formed by oxidation-reduction of an electrolyte gives a resistance electrically, and is considered to promote an increase in resistance particularly under a low-temperature environment in which the transfer rate of material becomes slow.

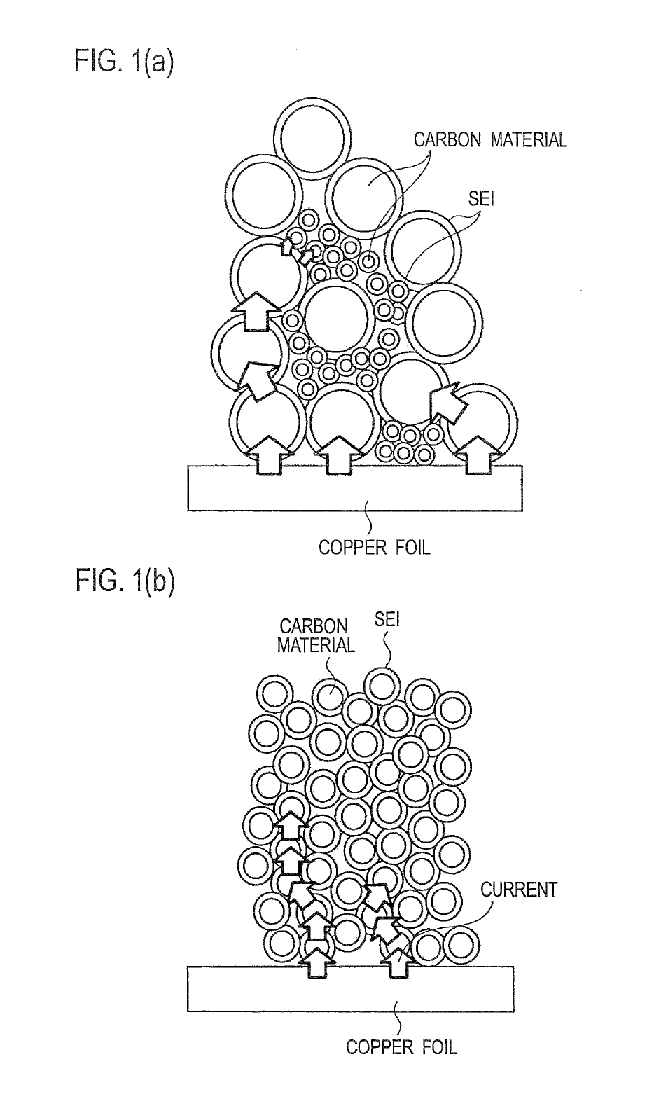

Referring to FIGS. 1(a) and 1(b), the electrical characteristics of the carbon material in this embodiment having a bimodal particle diameter distribution will be described in comparison with a carbon material with a single-peak particle diameter distribution. FIG. 1(a) shows a carbon material with a bimodal particle diameter distribution according to the present invention, and FIG. 1(b) shows a carbon material with a single-peak particle diameter distribution.

SEIs are formed on the surface of the carbon material. That is, by using a finely-pulverized carbon material, the frequency at which current passing through the carbonmaterial constituting a negative electrode passes through SEIs increases. The thickness of SEIs tends to depend on the carbon material, electrolyte, and temperature, but has almost no relationship with the particle diameter of the carbon material. Therefore, a decrease in the particle diameter leads to an increase in frequency at which current flowing through the carbon material passes through the SEIs. As a result, resistance under a low-temperature environment becomes higher, which is considered to be a cause of performance degradation at low temperatures. Thus, when the 50% volume cumulative diameter is sufficiently small, as it becomes smaller, resistance under a low-temperature environment tends to increase. On the other hand, it is considered that by setting the 50% volume cumulative diameter to 0.8 μm or more, a resistance increase at low temperatures within the carbon material can be reduced, and the resistance under a low-temperature environment can be reduced.

Further, the volume average particle diameter distribution of the carbon material for an electrical storage device of the present invention is controlled to have at least a second peak with the highest frequency of appearance and a first peak located on the side of a particle diameter smaller than that of the second peak. That is, the carbon material for an electrical storage device in this embodiment is so-called bimodal, having a second peak with a high frequency of appearance and a first peak present on the side of a particle diameter coarser than that.

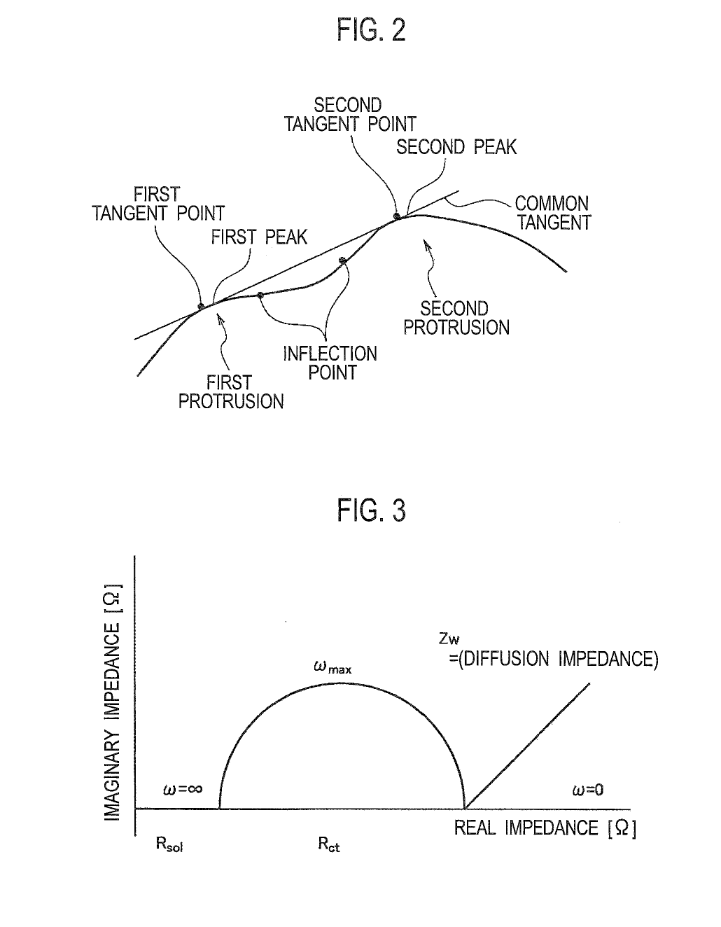

Being bimodal, specifically, means that when a particle diameter distribution is analyzed, at least two peak portions are found (a first peak and a second peak). The first peak referred to here is not limited to a portion observed as clearly showing a maximum. In a particle diameter distribution shown in FIG. 2, no clear maximum is seen. In this case, a first peak is evaluated to be included in a first protrusion, and a second peak is evaluated to be included in a second protrusion.

Specifically, a shoulder-like portion having a common tangent with the top of the second protrusion that is present on the side finer than the second peak in the volume average particle diameter distribution is the first protrusion. The first peak is present on the coarser side in the vicinity of a tangent point between the first protrusion and the tangent (first tangent point), and the value of its particle diameter can be approximated by the particle diameter at the first tangent point.

As for the relationship between the particle diameter distribution and the common tangent, the tangent contacts the first peak at the first tangent point, then is temporarily away from a distribution curve, and contacts it again at a second tangent point on the second protrusion without contacting a recess. Thus, there are at least two inflection points between the first tangent point and the second tangent point.

Information on scattered light intensity measured by the laser diffraction method is Fourier transformed, and given as a continuous distribution curve with the horizontal axis as the particle diameter and the vertical axis as the volume-based frequency. By at least first-order differentiating the distribution curve, a maximum, a minimum, and an inflection point can be identified. Specifically, at a maximum and a minimum, the first-order derivative values of the volume average particle diameter distribution become zero, and the maximum value is equivalent to a particle diameter corresponding to a peak. Further, based on the results of first-order differentiation and second-order differentiation, an inflection point of the particle diameter distribution can be identified. Having a particle diameter distribution thus evaluated as bimodal means that the carbon material can be broadly divided into two kinds, a carbon material with a larger particle diameter (a) and a carbon material with a smaller particle diameter (b).

The carbon material with the larger particle diameter constituting the second peak can reduce the frequency at which current flowing through the carbon material passes through SEIs, and thus can reduce resistance in the carbon material. As a result, this can contribute to excellent characteristics of the electrical storage device under a low-temperature environment. Specifically, first, the carbonmaterial with the larger particle diameter constituting the second peak forms a network of current with a lesser frequency of passing through the SEIs. Then, it is considered that the finer carbon material constituting the second peak or the shoulder is disposed in gaps of the carbon material with the larger particle diameter constituting the second peak. It is considered that these fine particles can increase the area of the interface between the carbon material and the electrolyte, increasing interfaces through which lithium ions move, and thus being able to ensure conductivity.

The above effect will be described based on FIGS. 1(a) and 1(b) in comparison with the case where the carbon material is formed with one peak. FIG. 1(a) shows the case where the carbon material is bimodal or has a shoulder. FIG. 1(b) shows the case where the carbon material is a carbon material formed with one peak.

It is considered that the flowing path of current in a system shown in FIG. 1 (a) tends to be a conductive path mainly through coarse particles. Therefore, when current flows to carbon particles located away from copper foil, it can be evaluated that the frequency at which the current passes through SEIs is reduced in the case in FIG. 1 (a) compared with the case in FIG. 1(b). Thus, in the case in FIG. 1(a), it is considered that current can be passed at a small resistance to the carbon material located away from the copper foil.

Bimodal carbon powder contains many fine carbon particles. A fine particle is high in the ratio of the surface area (specific surface area) to the volume. Containing many particles like this contributes to ensuring a sufficiently large surface area. Thus, it is considered that the interface between the carbon and the electrolyte through which lithium moves can be made sufficiently larger in the case in FIG. 1(a).

There is also a conceivable case where a weak peak whose particle diameter is small though other than two peaks as described above is seen, and the particle diameter distribution can be strictly evaluated as so-called multimodal. Being multimodal means that three or more peaks are seen in a strict sense. Such a case is considered as bimodal as long as it conforms to the above-described gist of the present invention.

In the carbon material for an electrical storage device according to this embodiment, the particle diameter distribution is preferably controlled such that the first peak is present in a first range in which the particle diameter is 0.01 μm or more to less than 1 μm, and the second peak is present in a second range in which the particle diameter is 1 μm or more to 10 μm or less. By the control to provide such a particle diameter distribution, the charge-transfer resistance value can be reduced more. In terms of further reducing the charge-transfer resistance value, the first peak is preferably included in a range of 0.2 μm or more to less than 1 μm, and is more preferably included in a range of 0.5 μm or more to less than 0.7 μm. In terms of the same, the second peak is more preferably included in a range of 1 μm or more to 5 μm or less.

In the carbon material for an electrical storage device according to this embodiment, the abundance ratio (X) between the carbon material (a) included in the first range and the carbon material (b) included in the second range is preferably in a range of 0.1 to 0.9. By controlling it to this value, the charge-transfer resistance value can be reduced more. In terms of further reducing the charge-transfer resistance value, the range of X is preferably from 0.2 to 0.8, and more preferably from 0.2 to 0.6, and most preferably from 0.3 to 0.5. The value of the X like this can be calculated based on the following Mathematical Formula 1:

$$\begin{matrix}[ Mathematical 2 ] & \\ X = \frac{A}{B} & ( Mathematical Formula 1 )\end{matrix}$$

(wherein, A represents the maximum frequency of appearance of the carbon material (a), and B represents the maximum frequency of appearance of the carbon material (b).)

In Mathematical Formula 1, the abundance ratio is determined by the maximum appearance frequencies at the peak positions for evaluation based on particle diameters representing their respective peaks. Here, the frequencies can be determined by a laser diffraction method using a laser diffraction type particle diameter distribution system. The maximum appearance frequencies are values determined by the particle diameter distribution with the horizontal axis as the logarithm of the particle diameter and the vertical axis as the abundance ratio. The particle diameter distribution can be obtained by dividing a cumulative particle diameter distribution at given intervals, and displaying the ratio of frequency included in one interval as an abundance ratio.

In the carbon material for an electrical storage device according to this embodiment, components constituting the second peak and components constituting the first peak are preferably obtained simultaneously by pulverizing a graphite material by a fluidized-bed jet mill.

Jet-mill systems include a collision-plate-type jet mill, a swirling-type jet mill, a fluidized-bed jet mill, and so on. Among them, the fluidized-bed jet mill is an apparatus that implements pulverization to the order of some μm by causing high-pressure air jetted from opposing nozzles to collide as ultrahigh-speedjets, and supplying particles into a region where airflows collide to produce impacts between the particles. This apparatus is also referred to as an airflow-type pulverizing apparatus.

The fluidized-bed jet mill has a pulverization mechanism based on collision between particles, and thus particles are considered to be pulverized in such a manner that their surfaces are cut away. As the particle diameter becomes smaller, it becomes difficult to pulverize particles more if collision between particles cannot provide energy enough to break them. Thus, a carbon material subjected to jet-mill pulverization does not tend to be over-pulverized, and thus a carbon material constituting a first peak is formed as one corresponding to a stable position in a particle diameter distribution.

As described above, the fluidized-bed jet mill is appropriate for a jet-mill system in this embodiment. By using this, a first peak can be formed in a nearly fixed position in a volume average particle diameter distribution while the 50% volume cumulative diameter of a carbon material is made gradually smaller. That is, a carbon material corresponding to a first peak and a carbon material corresponding to a second peak in the volume average particle diameter distribution can be simultaneously obtained. It is considered that a carbon material with small resistance at low temperatures can be obtained without over-pulverization since the particle diameter at the first peak is stable.

Further, it is considered that by the fluidized-bed jet mill, a bimodal carbon material can be easily obtained since a carbon material is pulverized, being circulated repeatedly within a pulverizing apparatus, and thus does not tend to be over-pulverized.

In a mechanical pulverizing apparatus that performs pulverization by friction pulverization or the like based on friction, impact, and the like with a large rigid body, strong impact generates fine particles, and thus it is considered that a broad particle diameter distribution tends to be formed. Therefore, it is considered that a carbon material with small resistance at low temperatures is hard to obtain.

An electrical storage device negative electrode according to this embodiment includes the carbonmaterial for an electrical storage device of the present invention. As described above, the carbon material for an electrical storage device of the present invention of the present invention can exhibit the characteristics of reducing resistance at low temperatures. Therefore, a negative electrode for the electrical storage device in this embodiment to which this is applied can also exhibit the characteristics of reducing resistance at low temperatures.

Further, an electrical storage device according to this embodiment includes the carbonmaterial for an electrical storage device of the present invention or the electrical storage device negative electrode of the present invention. As described above, the carbon material for an electrical storage device of the present invention and the electrical storage device negative electrode of the present invention can both exhibit the characteristics of reducing resistance at low temperatures. Therefore, the electrical storage device in this embodiment to which either of them is applied is reduced in resistance even under low temperatures, and can exhibit excellent characteristics. In this embodiment, the electrical storage device may be a lithium-ion secondary battery or a lithium-ion capacitor. By application like this, the lithium-ion secondary battery or the lithium-ion capacitor is reduced in charge-transfer resistance value, and can be improved in their output characteristics. In particular, for the lithium-ion capacitor, which handles current higher and larger than the lithium-ion battery, the carbonmaterial of the present invention with low internal resistance can be favorably used.

As described above, the carbon material for an electrical storage device according to this embodiment is controlled so as to have a desired particle diameter distribution, and thus can reduce charge-transfer resistance. By applying the carbon material for an electrical storage device as a negative electrode for an electrical storage device such as a negative electrode of a lithium-ion secondary battery or a negative electrode of a lithium-ion capacitor, these electrical storage devices can be improved in output characteristics.

[Method of Manufacturing Carbon Material for Electrical Storage Device]

Next, a method of manufacturing a carbon material for an electrical storage device according to this embodiment will be described.

A method of manufacturing a carbon material for an electrical storage device according to this embodiment includes a step of pulverizing a graphite material with air as a medium, using the above-described fluidized-bed jet mill.

The function of the jet mill is as described above. That is, it adopts a pulverization mechanism based on collision between particles, and thus performs pulverization such that the surfaces of the particles are cut away. As the particle diameter becomes smaller, it becomes difficult to pulverize particles more if collision between particles cannot provide energy enough to break them. Thus, a graphite material subjected to jet-mill pulverization does not tend to be over-pulverized. Therefore, through the above step, a carbonmaterial constituting a first peak is formed as one corresponding to a stable position in a particle diameter distribution.

By using the above-described jet mill, a first peak can be formed in a nearly fixed position in a volume average particle diameter distribution while the 50% volume cumulative diameter of a carbon material is made gradually smaller. That is, a carbon material corresponding to a first peak and a carbon material corresponding to a second peak in the volume average particle diameter distribution can be simultaneously obtained. It is considered that a carbon material with small resistance at low temperatures can be obtained without being over-pulverized since the particle diameter at the first peak is stable.

Further, it is considered that by a fluidized-bed jet mill, a bimodal carbon material can be easily obtained since it is pulverized, being circulated repeatedly within a pulverizing apparatus, and thus does not tend to be over-pulverized.

In a mechanical pulverizing apparatus that performs pulverization by friction pulverization or the like based on friction, impact, and the like with a large rigid body, strong impact generates fine particles, and thus it is considered that a broad particle diameter distribution tends to be formed. Therefore, it is considered that a carbon material with small resistance at low temperatures is hard to obtain.

The method of manufacturing the carbon material for an electrical storage device according to this embodiment can use natural graphite or synthetic graphite as the above-described graphite material. In terms of obtaining an optimized carbon material as one having a bimodal particle diameter distribution desired by the present invention, it is particularly preferable to use an isotropic graphite material containing amorphous cork as a raw material. Characteristics of an isotropic graphite material containing amorphous cork as a raw material include a low impurity content because its manufacturing process includes graphitization treatment. Further, the containment of an amorphous portion in raw materials increases the tendency of particles to be pulverized in such a manner that their surfaces are cut away. Therefore, it is considered that they do not tend to be over-pulverized and thus can reduce a resistance increase under a low-temperature environment.

For the operating conditions of the fluidized-bed jet mill, it is preferable in terms of pressure balancing in a pulverizer to form a pulverization system in which the pulverizer is connected to an airflow classifier, and adjust particle diameter distribution by the adjustment of the airflow classifier. The airflow classifier is an apparatus that uses a difference between a force acting on the mass of a powder particle and a force acting on its surface to classify powder. For the force acting on the mass of a powder particle, a centrifugal force, an inertial force, gravity, or the like is used, and for the force acting on the surface, a friction force caused by the flow of air is used. Generally, the classification is performed in the following manner. Specifically, the flow of air from the outside to the inside of a rotor rotating in the apparatus is formed, coarse particles with a small specific surface area are separated by a centrifugal force toward the outside of the rotor, and fine particles with a large specific surface area are separated with the flow of air toward the inside of the rotor.

Methods for making a carbon material to be obtained finer include increasing the number of revolutions of the rotor to increase the action of the centrifugal force, making the flow of air faster to increase the force acting on the surface of the powder, and the like. Further, a method of changing the pressure of compressed air at the pulverizer or the like may be used. Two or more of these methods may be combined. However, these methods are not intended to be limiting.

As described above, the method of manufacturing the carbon material for an electrical storage device according to this embodiment has the step of performing desired pulverization of a carbon material using a fluidized-bed jet mill, and thus is suitable for manufacturing a carbon material for an electrical storage device having a desired particle diameter distribution. That is, it can manufacture a carbon material significantly reduced in charge-transfer resistance under a low-temperature environment.

### Examples

Hereinafter, the present invention will be described in more detail with examples and comparative examples, but the present invention is not limited to these examples.

First, synthetic graphite was pulverized using a fluidized-bed jet mill manufactured by EARTHETECHNICA Co., Ltd, with air as a medium. A classifier is integrally incorporated in the fluidized-bed jet mill manufactured by EARTHETECHNICA Co., Ltd. The classification point was adjusted by changing the number of revolutions of a rotor in the classifier as appropriate, to prepare carbon materials with different 10% volume cumulative diameters (D10), 50% volume cumulative diameters (D50), and 90% volume cumulative diameters (D90) in Examples 1 to 4 and Comparative Examples 1 to 2. These values are summarized in Table 1.

TABLE 1

| | | | | First Peak | | Second Peak | | | Charge- |
|---|---|---|---|---|---|---|---|---|---|
| | | | | Volume Average | Maximum Appearance | Volume Average | Maximum Appearance | Abundance | Transfer |
| | D50 | D10 | D90 | Particle Size | Frequency A | Particle Size | Frequency A | Ratio X | Resistance |
| | μm | μm | μm | [μm] | [%] | [μm] | [%] | (%/%) | (Ω) |
| Example 1 | 2.89 | 0.84 | 5.39 | 0.69 | 1.3 | 3.57 | 6.8 | 0.20 | 7301.00 |
| Example 2 | 2.06 | 0.61 | 4.44 | 0.69 | 2.3 | 2.75 | 5.5 | 0.41 | 6369.60 |
| Example 3 | 1.50 | 0.55 | 3.22 | 0.69 | 3.1 | 1.95 | 5.2 | 0.60 | 6958.72 |
| Example 4 | 1.00 | 0.49 | 1.90 | 0.69 | 4.6 | 1.16 | 6.6 | 0.70 | 7925.98 |
| Comparative | 4.90 | 1.86 | 8.99 | 0.69 | 0.4 | 5.50 | 6.9 | 0.06 | 7970.00 |
| Example 1 | | | | | | | | | |
| Comparative | 0.79 | 0.41 | 1.51 | — | — | 0.89 | 6.5 | — | 8873.26 |
| Example 2 | | | | | | | | | |

Next, 5 parts by mass of acetylene black powder, 4 parts by mass of a SBR-based copolymer binder, 2 parts by mass of carboxymethyl cellulose (CMC), and 200 parts by mass of ion-exchange water were added to 90 parts by mass of the carbon materials in Examples 1 to 4 and Comparative Examples 1 to 2. By mixing these sufficiently by a mixing and stirring machine, negative electrode slurry according to Examples 1 to 5 was obtained.

The negative electrode slurry was applied to one surface of copper foil with a thickness of 18 μm, to have a solid weight of 1.0 g/cm², and was dried at 60° C. Then, electrodes were cut out to a diameter of φ1.5 mm, and dried further at 200° C. for two hours to produce the negative electrodes according to Examples 1 to 4 and Comparative Examples 1 to 2.

The negative foil electrodes and metal lithium with φ15 mm and a thickness of 20 μm to be the counter electrodes were disposed with a polyethylene separator with a thickness of 20 μm interposed therebetween, to form simulated cells according to Examples 1 to 4 and Comparative examples 1 to 2. As an electrolyte to be injected into these simulated cells, a solution in which LiPF₆ was dissolved to have a concentration of 1 mol/L in a mixed solvent with ethylene carbonate and diethyl carbonate at a weight ratio of 1:1 was used.

On the simulated cells, at 25° C., charge and discharge were conducted at an upper limit voltage of 2.0 V and a lower limit voltage of 0.01 V, and further charge and discharge were conducted at an upper limit voltage of 2.0 V and a lower limit voltage of 0.1 V. Then, these cells were subjected to alternating-current impedance measurements with frequency changed from 10 mHz to 1 MHz under an environment of −30° C. Based on data on measured alternating-current impedances, a complex plane graph (Cole-Cole plot) shown in FIG. 3 was created to measure and calculate R_{ct} in FIG. 3 as a charge-transfer resistance (Q) at −30° C. The results are also shown in Table 1.

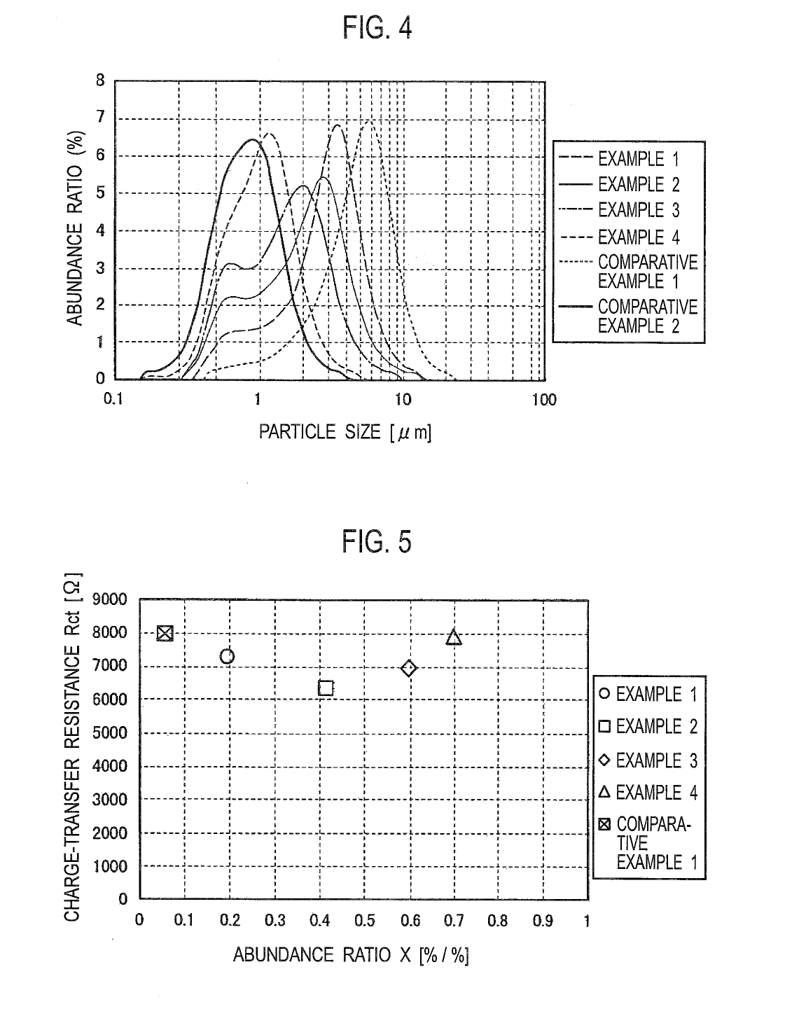

The graphite material after pulverization according to each example was subjected to a measurement using a laser-diffraction particle diameter distribution measurement apparatus (MT3300EX II; a NIKKISO CO., LTD. product). The measurement results are shown in FIG. 4. It was confirmed that the carbon materials according to Examples 1 to 3 each had a minimum between a first peak and a second peak in their respective particle diameter distributions. Example 4 had a particle diameter distribution in which there was a first peak having a common tangent with a second peak and there were two inflection points between the tangent points of the tangent and the first peak and the second peak. It was further confirmed that Examples 1 to 4 all had the first peaks included in a range of 0.01 μm or more to less than 1 μm, and the second peaks included in a range of 1 μm or more to 10 μm or less. Next, from these measurement results, the volume average particle diameter (μm) and the maximum frequency of appearance A (%) at the peak top of the first peak and the volume average particle diameter (μm) and the maximum frequency of appearance B (%) at the peak top of the second peak were determined, which are also shown in Table 1. Further, abundance ratios X were calculated from the values of A and B based on Mathematical Formula 1 described above. The values of X are also shown in Table 1. The relationship between the value of X and the charge-transfer resistance value in each example and that in each comparative example are also shown in FIG. 5.

As shown in Table 1 and FIG. 5, the cells in Examples 1 to 4 were found to be contained in a range of 0.1 to 0.9 in the values of X calculated based on Mathematical Formula 1. In the cells in the examples thus optimized in particle diameter distribution, the values of the charge-transfer resistances are 6.3 to 7.95 kΩ, which shows that they are sufficiently reduced as resistance values under a low-temperature environment.

The volume average particle diameter distributions shown in FIG. 4 show that Examples 1 to 3 each have a minimum value between the first peak and the second peak. Further, in Examples 1 to 3, the values of the charge-transfer resistances are 6.3 to 7.5 kΩ, which shows that they are further reduced as resistance values under a low-temperature environment.

By contrast, in Comparative Example 2, the presence of a second peak was confirmed, but the presence of a first peak could not be confirmed. The obtained values of the charge-transfer resistances in Comparative Example 1 and Comparative Example 2 were very high values, about 8.0 kΩ and 8.9 kΩ, respectively. That is, it was confirmed that the values of resistance of the cells according to these comparative examples under a low-temperature environment were higher than those of the carbon materials of the examples each having the at least one second peak with the highest frequency of appearance and the first peak on the smaller particle diameter side in the volume average particle diameter distributions.

The present invention has been described above with the examples and the comparative examples, but the present invention is not limited to them. Various alterations are possible within the scope of the gist of the present invention.

1. A carbon material for an electrical storage device made by pulverizing a graphite material, wherein
the 10% volume cumulative diameter is 0.45 μm or more to 1.7 μm or less, the 50% volume cumulative diameter is 0.8 μm or more to 4.0 μm or less, and the 90% volume cumulative diameter is 1.55 μm or more to 8.9 μm or less, and
the volume average particle diameter distribution has at least a second peak with the highest frequency of appearance and a first peak located on the side of a particle diameter smaller than that of the second peak.

2. The carbon material for an electrical storage device according to claim 1, wherein the first peak is present in a first range of 0.01 μm or more to less than 1 μm in particle diameter, and the second peak is present in a second range of 1 μm or more to 10 μm or less in particle diameter.

3. The carbon material for an electrical storage device according to claim 2, wherein the abundance ratio (X) between a carbon material (a) included in the first range and a carbon material (b) included in the second range determined by the following Mathematical Formula 1 is in a range of 0.1 to 0.9:
$$\begin{matrix}[ Mathematical 1 ] & \\ X = \frac{A}{B} & ( Mathematical Formula 1 )\end{matrix}$$
(wherein, A represents the maximum frequency of appearance of the carbon material (a), and B represents the maximum frequency of appearance of the carbon material (b).)

4. The carbon material for an electrical storage device according to claim 1, wherein components constituting the second peak and components constituting the first peak are simultaneously obtained by pulverizing the graphite material by a fluidized-bed jet mill.

5. A negative electrode for an electrical storage device comprising the carbon material for an electrical storage device according to claim 1.

6. An electrical storage device comprising the carbon material for an electrical storage device according to claim 1.

7. The electrical storage device according to claim 6 constituting a lithium-ion secondary battery or a lithium-ion capacitor.

8. A method of manufacturing the carbon material for an electrical storage device according to claim 1, the method comprising the step of pulverizing the graphite material by a fluidized-bed jet mill.

9. The method of manufacturing the carbon material for an electrical storage device according to claim 8, wherein an isotropic graphite material containing amorphous cork as a raw material is used as the graphite material.

10. An electrical storage device comprising the carbon material for an electrical storage device according to the negative electrode for an electrical storage device according to claim 5.
